(19) United States
(12) Patent Application Publication
(10) Pub. No.: US 2019/0292362 A1
(43) Pub. Date: Sep. 26, 2019

(54) Catalytically Active Radical Scavengers Based on Benzylic and Allylic Functionalities

(71) Applicant: Holland Novochem Technical Coatings B.V., Houten (NL)

(72) Inventors: Alexander Maslow, Deventer (NL); Erik Alexander Bijpost, Nieuwegein (NL)

(21) Appl. No.: 16/314,042

(22) PCT Filed: Jun. 29, 2017
(86) PCT No.: PCT/NL2017/000010

§ 371 Date: Dec. 28, 2018

(30) Foreign Application Priority Data
Jun. 29, 2016 (NL) 1041959
Jun. 29, 2016 (NL) 1041960

(51) Int. Cl. C08L 61/06; C08K 5/09; C08L 23/10; C08L 23/04; C08K 5/00; C08K 5/13

(52) U.S. Cl. CPC C08L 61/06; C08K 5/09; C08L 23/10; C09K 15/06; C08K 5/005; C08K 5/13; C08L 23/04

(57) ABSTRACT

An inhibitor to prevent oxidative radical degradation catalytically via a benzylic hydrogen abstraction mechanism and/or via an allylic hydrogen abstraction mechanism, effective in an amount of less than 1% (w/w) based on the solid weight of substrate or substrate composition. The inhibitor comprises a conjugated Hückel rule aromatic CH moiety. The aromatic moiety can be selected from benzene, naphthalene, anthracene, phenanthrene or other Hückel aromatic.

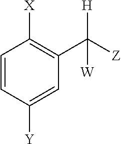

It is generally known that many polymers are prone to degradation, leading to brittleness, crack formation, discoloration etc. Especially for durable outdoor products and rubber tires, the life time is limited due to influence of daylight, UV and ozone, initiating random radical reactions (metastable singlet oxygen as main initiator). Many attempts have been undertaken to prevent degradation, ranging from addition of metal deactivators, UV absorbers, peroxide decomposers, free radical chain stoppers to inhibitor regenerators etc. All these solutions have in common that it is a temporary inhibition, because they will lose activity in time as quenching/trapping of radicals occurs stoichiometrically.

Apart from polymers, also a large group of monomers is prone to oxidation and/or radical-induced reactions. Known examples are styrene, divinylbenzene, acrylates, methacrylates, fatty acids etc. All these compounds have to be stabilized to prevent any reaction (decomposition/degradation) upon storage. Usually hydroquinones, 2,6-di-tert-butyl-p-cresol (BHT) and the like are applied to stabilize the systems by quenching radicals. These compounds will oxidize to an inactive thermodynamically stable compound. Hence, they act as stoichiometric radical scavengers.

Next to polymers and reactive monomers, many molecules and materials, containing an active abstractable C—H donor, e.g. toluene, xylene, benzylalcohol, ethers, natural oils, corresponding fatty acids, food stuff and beverages also will oxidize on ageing. These materials are not always stabilized.

### Proposed Mechanism of Radical-Induced Degradation

For the different types of polyalkylenes (linear vs. branched) the following pathways can be distinguished:

A. For linear polyalkylenes a radical, e.g. oxygen radical, hydroxyl radical, nitroxyl radical, sulfoxyl radical, sulfur radical, chlorine radical, nitrogen-centered radicals, such as triazenyls, aminyls and iminyls, will abstract a hydrogen radical from the polymer chain, forming a secondary reactive carbon radical. This species as such is very reactive, following mainly three pathways, viz. dimerization (cross-linking), addition and/or hydrogen abstraction from the matrix. Hardly any disproportionation or decomposition will occur. Owing to the dimerization the average molecular weight will increase in time, while the physical properties will change, such as brittleness and melting behavior (T_{g}).

B. For branched polyalkylenes, a radical, e.g. oxygen radical, hydroxyl radical, nitroxyl radical, sulfoxyl radical, sulfur radical, chlorine radical, nitrogen-centered radicals, such as triazenyls, aminyls and iminyls, will abstract also a hydrogen radical from the polymer backbone, forming a tertiary stabilized carbon radical. Predominantly an intramolecular disproportionation/cleaving will take place. The resulting degradation products will have a significantly lower average molecular weight in time. Consequently, the physical properties of the polymer will change as well.

### Invention

The objective of the present invention is to provide polymer-containing compositions with improved stability. Surprisingly, Applicant found that radical-initiated degradation of polymers, monomers and reactive materials can be prevented/inhibited catalytically. The inhibitor of choice comprises a benzylic type CH functionality, in particular a conjugated benzylic moiety due to mesomeric stabilization of the consecutive radical formed. The inhibitor of the invention may further be a allylic compound, such as itaconic acid, citraconic acid and their corresponding anhydrides, and derivatives, such as amides and imides, can stabilize the radical-induced degradation reactions. In a further embodiment, combinations of the benzylic-type inhibitor and the allylic compound. The preferred inhibitor comprises a benzylic type CH functionality, in particular a conjugated benzylic moiety.

Experiments have demonstrated that even under extreme conditions, e.g. storage under continuous air flow at 200° C. for 30 minutes, peak metal temperature (PMT) of 300° C. for 10 seconds, or under ozone treatment by gas high voltage UV-lamp, the polymers or polymer compositions predominantly maintain its original properties, proven by viscosity, color check, MEK rubbing of thin layers and minimal change in melting peak temperature Tₚₑₐₖ (DSC). When these polymers are not treated with the catalyst, the polymers exhibit a strong change in physical properties.

Benzylic compounds, such as alkylated phenols, condensated phenol resins and triphenylmethane and derivatives can stabilize the radical-induced degradation reactions as follows (for clarity only a benzyl compound, viz. alkylated phenol, is applied, but it is obvious for those skilled-in-the-art that the mechanism is in principle valid for most Hückel aromatics, including bi- and polycyclic aromatic, compounds, and bi- and polyphenols as well). However, most of these compounds cannot regenerate the catalytically active species, and will hence be used stoichiometrically. Additionally and similarly, allylic compounds, such as itaconic acid, citraconic acid and their corresponding anhydrides, and derivatives, such as amides and imides etc, can stabilize the radical-induced degradation reactions (for clarity only itaconic acid is applied, but it is obvious for those skilled-in-the-art that the mechanism is valid for corresponding compounds as well).

The catalysts or inhibitors according to the invention can act in the following route:

A. For linear polyalkylenes, upon oxidation highly reactive secondary alkyl radicals are formed. They abstract rapidly a benzylic hydrogen from the alkylated phenol. In case an allylic inhibitor is used, they abstract rapidly an allylic hydrogen from itaconic acid or the corresponding alternatives. Consequently, the linear polyalkylene polymer chain is reestablished and remains unaffected. The formed stable conjugated benzylic radical and/or the allylic radical will distract in time a hydrogen radical from the matrix, reestablishing the thermodynamically stable catalyst. Moreover, the reactive radical, e.g. oxygen radical, is deactivated by the alkylated phenol inhibitor, protecting the polyalkylene polymer to be attacked.

B. For branched polyalkylenes, upon oxidation more stable tertiary alkyl radicals are formed. Due to the structural properties branched polyalkylenes will predominantly give in-cage (intramolecular) disproportionation/degradation. This process is independent of the matrix. Consequently, preventing this process the aggressive radical has to be trapped/deactivated before it attacks the polymer backbone via the highly reactive conjugated benzylic type of inhibitor via donation of a hydrogen radical. The formed stable conjugated benzyl radical will absorb in time a hydrogen radical from the matrix, usually another neutral benzyl type molecule or termination via benzyl dimer/oligomer formation, reestablishing the catalyst property. In case of the allylic inhibitor, the formed stable allylic radical will absorb in time a hydrogen radical from the matrix, usually another neutral allylic itaconic acid or termination via itaconic acid dimer/oligomer formation, reestablishing the catalyst property.

It must be noted that thermal intramolecular disproportionation strongly depends on temperature. Upon severe heating (>200° C.) for a longer period of time, this thermal degradation process will dominate and the effect of radical catalytic inhibition will be negligible. Lowering the temperature will strongly diminish this thermally induced degradation process.

The efficiency of the catalytic activity to prevent radical-induced degradation is based on the ease of conjugated benzylic hydrogen abstraction, reactivity and stability as well as regeneration of the thermodynamically-favored benzylic hydrogen bond. All molecules with a benzylic hydrogen or the like are in principle able to inhibit radical-initiated decomposition of polymers. The lower the energy for hydrogen radical abstraction and the higher the degree of stabilization, the better the performance. However, most of these candidates will decompose/disproportionate and consequently become inactive as scavenger instead of reestablishing the catalytic property.

It is obvious for those skilled-in-the-art that polycyclic aromatic compounds, such as naphthalenes, anthracenes and phenanthrenes, as well as bi- and polyphenols, will show similar reactivity and stability. Moreover, bis- and tris benzyl substituted moieties can be applied as well as mono- di- and tribenzyl substituted phenols and corresponding dimers, oligomers and resins thereof. The higher the degree of conjugation the better the stabilization. Aromatic stabilization (conjugation) is the best driving force for catalytic activity of inhibitors and maintenance/stability of the polymers.

Next to carbon-based aromatics, components meeting the Hückel aromaticity rule can stabilize CH substituents via a ‘benzylic’ mechanism. Typical Hüuckel aromatic compounds are thiophene, pyridine, pyrazine, 1,3,5-triazine, melamine, oxazole and cyclopentadienyl anion. In addition, also substituted (Hückel) aromatics-grafted polymers can meet the criteria for catalytic radical scavengers. For clarity, only benzylic functionalities will be described, but it is obvious for those skilled-in-the-art that the invention is applicable for all CH-substituted Hückel aromatic compounds.

The inhibitors of choice contain the following functional moiety:

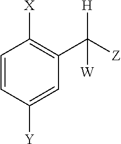

X and Y can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W and Z can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics. Those skilled-in-the-art know also that most of these functional groups can contain substituents as well. The catalytic mechanisms, however, will remain the same.

The invention further pertains to the use of an inhibitor of formula (1)

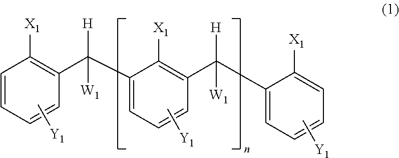

wherein n is a number from 0 to 1000, X₁ and Y₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics, for the catalytic scavenging of radicals.

In U.S. Pat. No. 4,222,884 anti-oxidants based on alkylated phenols are being disclosed. The preparation of these anti-oxidants in US'884 is carried out using potassium hydroxide and excess of para formaldehyde, which renders the formation of ether groups and a resol-type condensate. Moreover, the excess of formaldehyde further leads to cross-linking of oligomers of the alkylated phenols to form larger molecules. This makes the alkylated phenolic anti-oxidants of US'884 inefficient. The catalytic inhibitors of the invention are more efficient than the anti-oxidants of US'884.

The inhibitor of the invention is generally prepared under acidic conditions and with a stoichiometric or below-stoichiometric amount of the formaldehyde or corresponding reactants. In this way, the inhibitor will generally comprise the methylene groups on the ortho position of the X or X₁ substituent rendering an inhibitor of the novolac type (instead of the resol type). It is further noted that under these conditions no or hardly any ether groups are being formed.

The invention further pertains to the use of an inhibitor of formula (1)

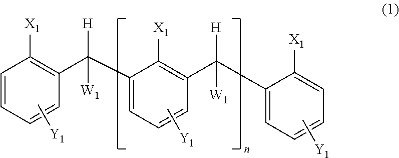

wherein n is a number from 0 to 1000, X₁ and Y₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics, in a polymer.

In one aspect, the invention pertains to an inhibitor of formula (1)

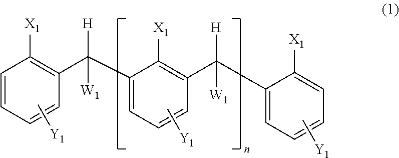

wherein n is a number from 0 to 1000, X₁ and Y₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics, for use in a polymer.

The present invention further pertains to a composition comprising a polymer and an inhibitor of the formula:

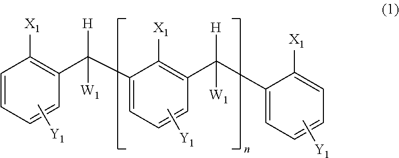

wherein n is a number from 0 to 1000, X₁ and Y₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics.

The composition of the invention exhibits an improved stability against degradation as compared to conventional polymer-containing compositions. The inhibitor of formula (1) contains a benzylic moiety which is capable of reacting with radicals formed in the polymer in a catalytic manner, i.e. without deterioration or inactivation of the properties of the compound itself. Conventional scavengers, such as quinones will only react once with the polymeric radical, and are generally not able to react with another radical, i.e. is inactivated. This allows the inhibitor of formula (1) to be present in much lower amounts than conventional scavengers. Moreover, the compositions of the invention generally prolong the life time of the polymer-containing composition of the invention as compared to conventional compositions.

The inhibitor of formula (1) generally has an n value of 0 to 1000. Preferably, n is at most 50, even more preferably at most 20, and most preferably at most 5, and preferably at least 2. In a preferred embodiment n is 2.

In one embodiment, the inhibitor of formula (1) comprises X₁ and is selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics, more preferably X₁ is hydrogen, hydroxyl, and chloride, even more preferably X₁ is hydrogen and hydroxyl, and most preferably X₁ is hydroxyl.

In another aspect, Y₁ is selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics, more preferably Y₁ is alkyl, hydrogen, hydroxyl, and chloride, even more preferably Y₁ is alkyl, hydrogen and hydroxyl, and most preferably Y₁ is alkyl.

In yet another aspect, W₁ is selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics, more preferably W is selected from hydrogen, methyl, ethyl, propyl, butyl and phenyl, and even more preferably W is selected from hydrogen and phenyl, and most preferably W₁ is hydrogen.

Typical candidates meeting these criteria of the inhibitor are not only alkylated phenols, phenol formaldehyde resins and triphenylmethane, but also bio-based compounds, such as lignins and lignosulfonates. They all comprise conjugated stabilized benzyl hydrogens, making them highly suitable for the catalytic inhibition of the oxidative radical-induced degradation. Further examples of inhibitors of formula (1) include triphenyl methane, diphenyl methane, phenyl chloromethane, diphenyl chloromethane, bis(2-hydroxyphenyl) methane, bis(3-hydroxyphenyl) methane, bis(4-hydroxyphenyl) methane, 2-hydroxyphenyl-3-hydroxyphenyl methane, 2-hydroxyphenyl-4-hydroxyphenyl methane, bis(2-hydroxyphenyl) chloromethane, bis(3-hydroxyphenyl) chloromethane, bis(4-hydroxyphenyl) chloromethane, 2-hydroxyphenyl-3-hydroxyphenyl chloromethane, 2-hydroxyphenyl-4-hydroxyphenyl chloromethane, bis(2-hydroxyphenyl) phenylmethane, bis(3-hydroxyphenyl) phenylmethane, bis(4-hydroxyphenyl) phenylmethane, 2-hydroxyphenyl-3-hydroxyphenyl phenylmethane, 2-hydroxyphenyl-4-hydroxyphenyl phenylmethane, bis(2-aminophenyl) methane, bis(3-aminophenyl) methane, bis(4-aminophenyl) methane, 2-aminophenyl-3-aminophenyl methane, 2-aminophenyl-4-aminophenyl methane, bis(2-aminophenyl) chloromethane, bis(3-aminophenyl) chloromethane, bis(4-aminophenyl) chloromethane, 2-aminophenyl-3-aminophenyl chloromethane, 2-aminophenyl-4-aminophenyl chloromethane, bis(2-aminophenyl) phenylmethane, bis(3-aminophenyl) phenylmethane, bis(4-aminophenyl) phenylmethane, 2-aminophenyl-3-aminophenyl phenylmethane, 2-aminophenyl-4-aminophenyl phenylmethane, bis(2-mercaptophenyl) methane, bis(3-mercaptophenyl) methane, bis(4-mercaptophenyl) methane, 2-mercaptophenyl-3-mercaptophenyl methane, 2-mercaptophenyl-4-mercaptophenyl methane, bis(2-mercaptophenyl) chloromethane, bis(3-mercaptophenyl) chloromethane, bis(4-mercaptophenyl) chloromethane, 2-mercaptophenyl-3-mercaptophenyl chloromethane, 2-mercaptophenyl-4-mercaptophenyl chloromethane, bis(2-mercaptophenyl) phenylmethane, bis(3-mercaptophenyl) phenylmethane, bis(4-mercaptophenyl) phenylmethane, 2-mercaptophenyl-3-mercaptophenyl phenylmethane, 2-mercaptophenyl-4-mercaptophenyl phenylmethane, alkylated phenols, such as 2-methylphenol, 2-ethylphenol, 2-propylphenol, 2-butylphenol, 3-methylphenol, 3-ethylphenol, 3-propylphenol, 3-butylphenol, 4-methylphenol, 4-ethylphenol, 4-propylphenol and 4-butylphenol and phenoplasts having from 2 to 1000 repeating units (i.e. an inhibitor of formula (1) with n is from 0 to 1000, X₁ is hydroxyl, Y₁, and W₁ are hydrogen).

Naphthalenes, anthracenes and the like as well as Hückel rule benzylic CH compounds are capable of acting as catalyst for polymer stabilization as well. In addition, several natural compounds comprises also benzylic moieties, such as lignin's and the corresponding sulfonates. The higher the degree of radical stabilization (conjugation), the better the performance of the catalyst.

It is clear for those skilled-in-the-art that the capacity of the catalytic inhibitor is concentration dependent. To prevent alkyl radical formation side reaction, the concentration of the catalyst should be sufficiently present to prevent attack to the polymer. This depends on the conditions, e.g. solid or liquid, dynamic or static, temperature, diffusion, viscosity, matrix, porosity etc. This is well-known to those skilled-in-the-art. The relative concentration is also depending on reaction kinetics equilibria of the speed of deactivating the oxygen radical and the rate of reestablishing the catalyst property. The higher the amount of stabilizer, the higher the stability and resistance of the polymer or other substrates under extreme oxygen radical attack induced conditions: sunlight, UV, temperature, oxygen, ozone, peroxide, metals and corresponding oxides.

In one embodiment of the invention, the composition comprises the inhibitor of formula (1) in an amount of at least 0.0001% by weight (wt %), based on the total weight of composition. Preferably, the inhibitor of formula (1) is present in an amount of at least 0.05 wt %, more preferably at least 0.1 wt %, even more preferably at least 0.15 wt % and most preferably at least 0.2 wt %, and preferably at most 30 wt %, more preferably at most 20 wt %, even more preferably at most 10 wt %, even more preferably at most 5 wt %, even more preferably at most 2 wt %, and most preferably at most 0.1 wt %, based on the total weight of the composition. It must be noted that ppm levels of (1) show already catalytic inhibition activity.

The remaining part of the composition of the invention may comprise of other components commonly used in such compositions. With the polymer and the inhibitor of formula (1) the other components add up to 100 wt % of the total weight of the composition.

In one embodiment of the invention, the composition comprises the polymer and the inhibitor of formula (1) in a weight ratio of polymer and inhibitor of formula (1) of at least 0.01, preferably at least 0.10, more preferably at least 1, even more preferably at least 30, and preferably at most 200, more preferably at most 10000, even more preferably at most 75, and most preferably at most 50. All values between 1 ppm and 25% (w/w) of formula (1) in the polymer composition are applicable depending on the conditions of the stabilization to be performed. Under harsh conditions more catalyst/stabilizer is required.

The inhibitors of choice contain the following functional moiety:

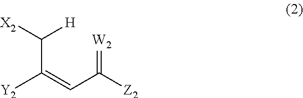

X₂ and Y₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

And wherein the inhibitor can be a linear or cyclic anhydride.

The invention further pertains to the use of an inhibitor of formula (2)

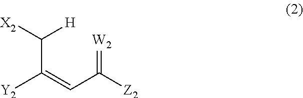

wherein X₂ and Y₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics. The substitution on the aromatic ring can be ortho, meta and/or para as well as higher substituted aromatic rings, for the catalytic scavenging of radicals,

and wherein the inhibitor optionally is a linear or cyclic anhydride.

The invention further pertains to the use of an inhibitor of formula (2)

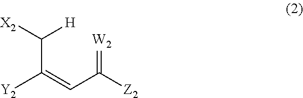

wherein X₂ and Y₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics,

and wherein the inhibitor optionally is a linear or cyclic anhydride; the substitution on the aromatic ring can be ortho, meta and/or para as well as higher substituted aromatic rings, in a polymer.

In one aspect, the invention pertains to an inhibitor of formula (2)

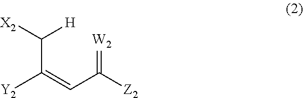

wherein X₂ and Y₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics,

and wherein the inhibitor optionally is a linear or cyclic anhydride; the substitution on the aromatic ring can be ortho, meta and/or para as well as higher substituted aromatic rings, for use in a polymer.

The present invention further pertains to a composition comprising a polymer and an inhibitor of the formula:

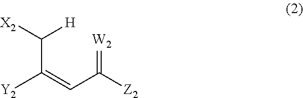

wherein X₂ and Y₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics,

and wherein the inhibitor optionally is a linear or cyclic anhydride; the substitution on the aromatic ring can be ortho, meta and/or para as well as higher substituted aromatic rings.

The composition of the invention exhibits an improved stability against degradation as compared to conventional polymer-containing compositions. The inhibitor of formula (2) contains an allylic moiety which is capable of reacting with radicals formed in the polymer in a catalytic manner, i.e. without deterioration or inactivation of the properties of the compound itself. Conventional scavengers, such as quinones will only react once with the polymeric radical, and are generally not able to react with another radical, i.e. is inactivated. This allows the inhibitor of formula (1) to be present in much lower amounts than conventional scavengers. Moreover, the compositions of the invention generally prolong the life time of the polymer-containing composition of the invention as compared to conventional compositions.

In one embodiment, the inhibitor of formula (2) comprises X, Y and Z are selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics, more preferably Z is hydrogen, hydroxyl, and chloride, even more preferably X is hydrogen and hydroxyl, and most preferably Z is hydroxyl. In another aspect, W is selected from oxygen, sulphur, nitrogen-containing groups or phosphor-containing, preferably W is oxygen. X and Y are independently selected from hydrogen, substituted and unsubstituted alkyl, and substituted and unsubstituted aryl, polycyclic aromatics, substituted polyaromatics, more preferably X and Y are independently selected from hydrogen, methyl, ethyl, propyl, butyl and phenyl, and even more preferably W is selected from hydrogen and phenyl, and most preferably X and Y are independently hydrogen.

Typical candidates meeting these criteria of the inhibitor are itaconic acid and citraconic acid. They comprise, two and three allylic hydrogen, respectively, making them highly suitable for the catalytic inhibition of the oxidative radical-induced degradation. Further examples of inhibitors of formula (2) include dimethyl itaconate ester, dibutylitaconate ester, mesaconic acid, 1,3-butadiene-1,4-dicarboxylic acid and 2,4-pentadienoic acid, cyclopentenone, cyclohexenone, 3-methyl-2-cyclohexenone and 2-methyl-2-cyclohexen-1-one.

The alkene-carboxylic group can form tautomers, giving the stabilization and reactivity to trap a radical and regenerate the active species. Those skilled in-the-art knows that several carboxylic derivatives, such as amidines, imides, amides can also stabilize allylic radicals.

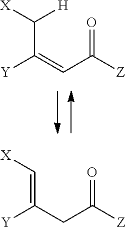

It is clear for those skilled-in-the-art that the capacity of the catalytic inhibitor is concentration dependent. To prevent alkyl radical formation side reaction, the concentration of the catalyst should be sufficiently present to prevent attack to the polymer. This depends on the conditions, e.g. solid or liquid, dynamic or static, temperature, diffusion, viscosity, matrix, porosity etc. This is well-known to those skilled-in-the-art. The relative concentration is also depending on reaction kinetics equilibria of the speed of deactivating the oxygen radical and the rate of reestablishing the catalyst property. The higher the amount of stabilizer, the higher the stability and resistance of the polymer or other substrates under extreme oxygen radical attack induced conditions: sunlight, UV, temperature, oxygen, ozone, peroxide, metals and corresponding oxides.

It must be noted that grafted itaconic acid on polymers cannot show the same catalytic activity/polymer stabilization, as the allylic functionality has disappeared due to reaction with the polymer upon grafting. On the other hand, dimers, oligomers and polymers derived from allylic compounds, such as itaconic acid, usually contain an allylic end group. These moieties can be active as inhibitor for radical scavenging, e.g. through a linking group like a methylene group.

In one embodiment of the invention, the composition comprises the inhibitor of formula (2) in an amount of at least 0.0001% by weight (wt %), based on the total weight of composition. Preferably, the inhibitor of formula (2) is present in an amount of at least 0.05 wt %, more preferably at least 0.1 wt %, even more preferably at least 0.15 wt % and most preferably at least 0.2 wt %, and preferably at most 30 wt %, more preferably at most 20 wt %, even more preferably at most 10 wt %, even more preferably at most 5 wt %, even more preferably at most 2 wt %, and most preferably at most 1 wt %, based on the total weight of the composition. It must be noted that ppm levels of (2) show already catalytic activity.

The remaining part of the composition of the invention may be comprised of other components commonly used in such compositions. With the polymer and the inhibitor of formula (2) the other components add up to 100 wt % of the total weight of the composition.

In one embodiment of the invention, the composition comprises the polymer and the inhibitor of formula (2) in a weight ratio of polymer and inhibitor of formula (2) of at least 0.01, preferably at least 0.10, more preferably at least 1, even more preferably at least 30, and preferably at most 200, more preferably at most 10000, even more preferably at most 75, and most preferably at most 50. All values between 1 ppm and 25% are applicable depending on the conditions of the stabilization to be performed. Under harsh conditions more catalyst/stabilizer is required.

In another embodiment, the conjugated allylic inhibitors can be combined with the benzylic compounds according this invention, present in one single molecule, grafted thereon or intrinsically chemically incorporated in the molecule. It is evident for those skilled-in-the-art that molecules, comprising both an allylic moiety and a benzylic (or Hückel rule aromatic CH) moiety, can show catalytic activity in radical scavenging as well. In a further embodiment of the invention, the allylic and/or benzylic inhibitor can be grafted to the polymer or oligomer which it should stabilize from degradation in such a way that the mesomeric radical stabilization in the inhibitor is maintained. This can be obtained through a linking group like a methylene group, while maintaining the mesomeric radical stabilization properties.

Those skilled-in-the-art know that catalytic inhibition of radical-induced reactions can be applied to many processes. All polymers in general are susceptible to oxy radical-induced attack/decomposition, e.g. polyethylene, polypropylene, homo-, co- and terpolymers as well as functionalized polymers, such as maleic-grafted polymers. With the new invention these polymers can be stabilized catalytically instead of using traditional scavengers. In line with this invention, also monomers, reactive solvents and other materials like food stuff and beverages, susceptible to oxidation in time upon storage, can be stabilized.

It is evident that also oxygen containing radicals can be stabilized analogously. Typical examples of such radicals are oxygen-, hydroxyl-, peroxy-, aryloxy-, alkoxy-, alkylperoxy-, arylcarbonate- and alkylcarbonate-radicals and ozone.

The polymer can be any polymer that can be suitably used in the composition of the invention. As above mentioned, polymers are used that may degrade by a radical mechanism e.g. by exposure to sunlight (UV), temperature, oxygen, ozone, peroxide, metal and/or metal oxides. Polymers susceptible to formation of a radical are of particular interest. The polymer may be a homopolymer, a copolymer or a terpolymer. In this specification, the term “polymer” refers to an organic substance of at least two building blocks (i.e. monomers), thus including oligomers, copolymers and polymeric resins and the corresponding functionalized resins. The (co)polymers generally have a degree of polymerization of at least 20, more preferably at least 50. In this connection, for a definition of the degree of polymerization, reference is made to P. J. Flory, Principles of Polymer Chemistry, New York, 1953.

Examples of suitable polymers are polyolefins, such as polyethylene and polypropylene as well as grafted polyolefins; vinyl polymers, such as polystyrene, polymethyl methacrylate, polyvinyl chloride, polyvinylidene chloride or polyvinylidene fluoride, and blends of two or more polymers. Preferred polymers are polyolefins, vinyl polymers, polyesters, polycarbonates, polyamides, polyurethanes, polyepoxides, polyvinylalcohol, polyvinylacetaat, polyethers or polythioethers.

In a further embodiment of the invention, the polymer is a thermoplastic polymer. Examples of thermoplastic polymers include polyethylene, polypropylene, grafted polyolefins, and polystyrene; acetal (co)polymers, such as polyoxymethylene (POM); rubbers, such as natural rubber (NR), styrene-butadiene rubber (SBR), polyisoprene (IR), polybutadiene (BR), polyisobutylene (IIR), halogenated polyisobutylene, butadiene nitrile rubber (NBR), hydrogenated butadiene nitril (HNBR), styrene-isoprene-styrene (SIS) and similar styrenic block copolymers, poly(epichlorohydrin) rubbers (CO, ECO, GPO), silicon rubbers (Q), chloroprene rubber (CR), ethylene propylene rubber (EPM), ethylene propylene diene rubber (EPDM), polysulfide rubber (T), fluorine rubbers (FKM), ethane-vinylacetate rubber (EVA), polyacrylic rubbers (ACM), polynorbornene (PNR); polyurethanes (AU/EU) and polyester/ether thermoplastic elastomers.

Particularly preferred are polymers or copolymers obtained by polymerization of at least one ethylenically unsaturated monomer. Such polymers include polyolefins and modified polyolefins, which are known to the man skilled-in-the-art. The polyolefin or modified polyolefin can be a homopolymer or a copolymer, terpolymer of grafted polymer. Examples of such (modified) polyolefins include polyethylene, polypropylene, polybutylene, polystyrene, polyvinyl chloride, polyvinylidene chloride and ethylene-propylene rubber, propylene-butene copolymer, ethylene-vinyl chloride copolymer, ethylene-vinyl acetate copolymer, acrylonitrile-butadiene-styrene copolymer (ABS), acrylonitrile-acrylate-styrene copolymer (AAS), methyl methacrylate-butadiene-styrene copolymer (MBS), chlorinated polyethylene, chlorinated polypropylene, ethylene-acrylate copolymer, vinyl chloride-propylene copolymer, maleic anhydride-grafted polyolefin, maleic acid-grafted polyolefin, and mixtures thereof. More preferred polyolefins are polyethylene, polypropylene, polystyrene and polyvinyl chloride.

Suitable examples of polyethylene are high-density polyethylene (HDPE), low-density polyethylene (LDPE), straight chain low-density polyethylene, ultra-low density polyethylene and ultra-high molecular weight polyethylene. Further examples of ethylene-based copolymers include ethylene-vinyl acetate copolymer (EVA), ethylene-ethyl acetate copolymer (EEA), ethylene-methyl acrylate copolymer (EMA) and ethylene-acrylic acid copolymer (EAA).

Preferred polyolefins are polyethylene and polypropylene, which include emulsions and dispersions thereof. Such emulsions and dispersions can be water-based or solvent-based. The inhibitor of the invention can be used in both water-based and solvent-based emulsions and dispersions. Examples of such polyolefin dispersions or emulsions include Mitsui Unisol R100 G, Mitsui XPO4A, Mitsui 5300, Mitsui Chemipearl W900 and Dow Canvera 1110.

In one embodiment of the invention, the composition comprises the polymer in an amount of at least 50% by weight (wt %), based on the total weight of composition. Preferably, the polymer is present in an amount of at least 60 wt %, more preferably at least 70 wt %, even more preferably at least 75 wt % and most preferably at least 80 wt %, and preferably at most 99.999 wt %, more preferably at most 99.5 wt %, even more preferably at most 99 wt %, even more preferably at most 98 wt %, even more preferably at most 96 wt %, and most preferably at most 95 wt %, based on the total weight of the composition.

The invention further pertains to a masterbatch comprising 0.01 to 40 wt % of the inhibitor of formula (1) and 60 to 98 wt % of a polymer. Preferably, a masterbatch comprises at least 0.1 wt % of the inhibitor of formula (1) and/or the inhibitor of formula (2), more preferably at least 1 wt % and most preferably at least 5 wt %, and preferably at most 30 wt %, more preferably at most 20 wt %, even more preferably at most 15 wt %, and most preferably at most 10 wt % of the inhibitor of formula (1) and/or the inhibitor of formula (2), based on the total weight of the masterbatch. Correspondingly, the masterbatch comprises at least 60 wt % of the polymer, more preferably at least 80 wt %, even more preferably at least 85 wt % and most preferably at least 90 wt %, and preferably at most 99 wt %, more preferably at most 96 wt %, and most preferably at most 95 wt % of the polymer, based on the total weight of the masterbatch. Such masterbatches are highly concentrated premixes for polymer compounding, for example. Such masterbatches are generally blended with another polymer. The further polymer may be the same or different polymer as used in the masterbatch.

The compositions of the invention including the masterbatch may further comprise additives commonly used in polymer-containing compositions including pigments and dyes, heat stabilizers, anti-oxidants, fillers, such as hydroxyapatite, silica, carbon black, glass fibers and other inorganic materials, flame retardants ,nucleating agents, impact modifiers, plasticizers, rheology modifiers, cross-linking agents, anti-gassing agents, surfactants, flow controlling agents, ultraviolet light (UV) stabilizers, adhesion enhancing promoters, waxes, matting agents, defoamers and curing catalysts.

The inhibitor of formula (1) and/or the inhibitor of formula (2) generally obviates the addition of a further UV stabilizer. Examples of pigments and dyes include metal oxides like iron oxide, zinc oxide and; metal hydroxides; metal sulfides, metal sulfates, metal carbonates, such as calcium carbonate; carbon black, china clay, phthalo blues and greens, organo reds and other organic dyes.

The additives are optional and can be chosen according to need in amounts as desired. The composition of the invention may comprise the additives in an amount of at most 30% by weight (wt %), based on the total weight of the composition. Preferably, the additive is present in an amount of at most 25 wt %, more preferably at most 20 wt %, even more preferably at most 15 wt % and most preferably at most 30 wt %, and preferably at least 1 wt %, more preferably at least 2 wt %, even more preferably at least 5 wt % and most preferably at least 10 wt %, based on the total weight of the composition.

The invention further pertains to a process for preparing a composition comprising a polymer and an inhibitor of formula (1):

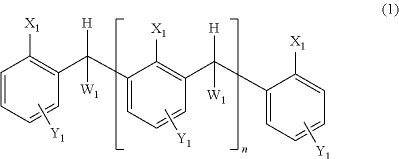

wherein n is a number from 0 to 1000, X₁ and Y₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted benzene molecules are also suitable and available, and can meet also the criteria for conjugated benzylic activity.

W₁ can be independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, amides, esters, carbonyls, epoxies, oxetanes, oxiranes, ethers, carboxylic acids, sulfonates, sulfonic acids, phosphonic acids and heterocyclics, comprising the steps of:

a) contacting the polymer and the inhibitor of formula (1); and

b) mixing the polymer and the inhibitor of formula (1) to form the composition.

The invention further pertains to a process for preparing a composition comprising a polymer and an inhibitor of formula (2):

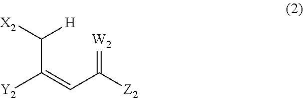

wherein X2 and Y2 can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, ketones, aldehydes, ethers, carboxylic acids, sulfonates, sulfonic acids, phosphonic acids and heterocyclics. The substitution on the aromatic ring can be ortho, meta and/or para. Higher substituted aromatic rings are also available and suitable.

W₂ can be selected from oxygen, sulphur, nitrogen-containing groups or phosphor-containing groups.

Z₂ can be selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, such as alcohol, amines, amino derivative or the corresponding salts (ligands), ketones, aldehydes, ethers, carboxylic acids, sulfonates, sulfonic acids, phosphonic acids and heterocyclics. The substitution on the aromatic ring can be ortho, meta and/or para as well as higher substituted aromatic rings, comprising the steps of:

b) contacting the polymer and the inhibitor of formula (2); and

b) mixing the polymer and the inhibitor of formula (2) to form the composition.

The process of the invention may be conducted using any suitable method known in the art to blend or mix the polymer and the inhibitor of formula (1) and/or the inhibitor of formula (2), for example melt-blending techniques. Examples of compounding processes that can be suitably used in the process of the invention include batch mixing using mixers, such as non-intermeshing rotor mixers, intermeshing rotor mixers, internal rotor mixers; and continuous mixing using mixers, such as single-screw extruders, co-rotating twin-screw extruders, tangential counter-rotating twin-screw extruders, modular intermeshing counter-rotating twin-screw mixer and modular Buss Kokneter.

The substrate of the invention can be any substrate known-in-the-art. The substrate may be porous or non-porous. Examples of suitable substrates include metals, such as aluminum, aluminum alloys, steel, steel alloys, tin, tin allows, zinc, zinc alloys, chrome and chrome alloys; glass, such as fused silica glass, aluminosilicate glass, soda-lime-silica glass, borosilicate glass and lead-oxide glass; ceramics, such as porcelain, bone china, alumina, ceria, zirconia, carbides, borides, nitrides and silicides; plastics, such as functionalized polyethylene (PE), functionalized polypropylene (PP), polyethylene terephthalate (PET), polyvinyl chloride (PVC) and nylons; and wood.

In the context of the present application the term “cure” or “cured” refers to the process of hardening of the composition by polymerization and/or crosslinking. This curing process can be initiated by exposure to heat, such as by infrared radiation, by microwave radiation or by heating, e.g. in an oven, electron beams and chemical additives. The compositions of the invention preferably cure through exposure to heat. The polymer mixtures according to the invention can withstand long baking times as well as very high peak metal temperatures (300° C.) without degradation.

The compositions of the invention may also be processed and shaped using techniques known in the art. Examples of such processing techniques include melt spinning, die extrusion, injection molding, compression and transfer molding, thermoforming, rotational molding and sintering, blow molding, plastic foam molding, extrusion and extrusion-based techniques, such as pipe extrusion, sheet extrusion, tubular blown film extrusion, melt spinning, netting, and co-extrusion.

In a further embodiment of the invention, the composition of the invention can be used in any application for which the composition of the invention is suitable. Examples of such applications include carpeting, automobile parts, window frames, kitchen worktops, container closures, lunch boxes, closures, medical devices, household articles, food containers, dishwashers, outdoor furniture, blow-molded bottles, disposable non-woven fabrics, cables and wires and packaging. These applications have in common that the life time can be extended substantially owing to preventing oxidative degradation on the surface.

In a further embodiment of the invention, the composition of the invention can be used to increase the shelf life of natural oils, fatty acids, food stuff, wine and other beverages prone to oxidation can be increased substantially by compounds according to this invention as well.

In a further embodiment of the invention, the composition of the invention can be used to increase the stability of solvents and reactive monomers, containing an active abstractable C—H donor, e.g. toluene, xylene, benzylalcohol, ethers, natural oils and corresponding fatty acids.

In a further embodiment of the invention, the composition of the invention can be used to increase the stability of automobile paints and decorative paints.

In a further embodiment of the invention, the composition of the invention can be used to increase the stability of azo compounds, organic peroxides, organic peroxy acids and organic peroxy esters.

### EXAMPLES

The invention is exemplified in the following examples.

### Examples 1 to 5 and Comparative Examples A and B: Benzylic Inhibitor

A 100 ml open glass vessel is charged with 10 grams of polymer. A defined amount of inhibitor is added and thoroughly stirred. The mixture is heated up to 200° C. in a Gallenkamp box oven. When the polymer has reached the softening point, the mixture is again thoroughly stirred. Then a continuous air flow is passed through the oven, allowing the mixture to come into contact with oxygen. The physical properties are monitored in time. Tₚₑₐₖ values have been determined by DSC (Mettler DSC 12E, 80° C.-250° C., rate: 10° C./min).

| Example | Polymer | Inhibitor (% w/w) | Observations 30 min @ 200° C. | Tₚₑₐₖ (° C.) |
|---|---|---|---|---|
| A | PP | No heating | n.a. | 163 |
| A | PP | 0 | Clear liquid, yellowing on top | 153 |
| 1 | PP | 0.5% Substituted phenol | Clear yellow liquid | 164 |
| | | formaldehyde resin | | |
| 2 | PP | 0.05% Substituted phenol | Clear yellow liquid | 164 |
| | | formaldehyde resin | | |
| 3 | PP | 0.05% Itaconic acid + | Clear yellow liquid | 163 |
| | | 0.05% Substituted phenol | | |
| | | formaldehyde resin | | |
| B | LLDPE | No heating | n.a. | 124 |
| B | LLDPE | 0 | Clear liquid slightly yellow | 121 |
| 4 | LLDPE | 0.10% Substituted phenol | Clear liquid slightly yellow | 124 |
| | | formaldehyde resin | | |
| 5 | LLDPE | 0.05% Itaconic acid + | Clear liquid slightly yellow | 124 |
| | | 0.05% Substituted phenol | | |
| | | formaldehyde resin | | |

It can be concluded from the examples that radical-induced degradation reactions can be inhibited by benzylic fragments containing compounds, such as substituted phenol formaldehyde resin. Even catalytic amounts of inhibitor added show the same activity. Upon mixing and/or combining these compounds with a functionalized allylic compound, such as itaconic acid, the catalytic radical scavenging effect is maintained as well. It must be noted that yellowing in the processed examples is not caused by degradation, but by the intense yellow color of the phenoplast as such.

### Examples 6 to 11 and Comparative Examples C and D: Allylic Inhibitor

A 100 ml open glass vessel is charged with 10 grams of polymer. A defined amount of inhibitor is added and thoroughly stirred. The mixture is heated up to 200° C. in a Gallenkamp box oven. When the polymer has reached the softening point, the mixture is again thoroughly stirred. Then a continuous air flow is passed through the oven, allowing the mixture to come into contact with oxygen. The physical properties are monitored in time. Tₚₑₐₖ values have been determined by DSC (Mettler DSC 12E, 80° C.-250° C., rate: 10° C./min).

| Example | Polymer | Inhibitor (% w/w) | Observations 30 min @ 200° C. | Tₚₑₐₖ (° C.) |
|---|---|---|---|---|
| C | PP | No heating | n.a. | 163 |
| C | PP | 0 | Clear slightly yellow liquid | 153 |
| 6 | PP | 1% Itaconic acid | Clear yellow liquid | 159 |
| 7 | PP | 0.05% Itaconic acid | Clear yellow liquid | 158 |
| 8 | PP | 1% Citraconic anhydride | Clear slightly yellow | 155 |
| 9 | PP | 0.05% Itaconic acid + 0.05% | Clear yellow | 163 |
| | | Substituted phenol | | |
| | | formaldehyde resin | | |
| D | LLDPE | No heating | n.a. | 124 |
| D | LLDPE | 0 | Clear liquid slightly yellow | 121 |
| 10 | LLDPE | 0.05% Itaconic acid | Clear liquid slightly yellow | 122 |
| 11 | LLDPE | 0.05% Itaconic acid + 0.05% | Clear liquid slightly yellow | 124 |
| | | Substituted phenol | | |
| | | formaldehyde resin | | |

It can be concluded from the examples that radical-induced degradation reactions can be inhibited by functionalized allylic compounds, such as itaconic acid and citraconic anhydride. Even catalytic amounts of inhibitor added show the same activity. Upon mixing and/or combining these compounds with a conjugated benzyl compound, substituted phenol formaldehyde resin, a pronounced catalytic radical scavenging effect can be obtained as well.

### Examples 12 to 24 and Comparative Examples E to Q.: Allylic and Benzylic Inhibitors

A 100 ml open glass vessel is charged with 10 grams of polymer or polymer emulsion as indicated in the Table below. Two samples were taken; in one 0.1 wt % of inhibitor is added and thoroughly stirred.

When a different amount is added to the polymer, it is specifically indicated in the Table below. In Comparative Examples K to Q, the condensates were prepared according to Example 1 of U.S. Pat. No. 4,222,884, i.e. under alkaline conditions creating resol-type condensates.

| Example | Polymer | Description | Inhibitor (0.1% w/w) |
|---|---|---|---|
| E | Mitsui Unisol | Polypropylene dispersion | No additive |
| | R100-G | solvent-based | |
| 12 | Mitsui Unisol | Polypropylene dispersion | SFC 112-65 (4-t-Butylphenol- |
| | R100-G | solvent-based | Formaldehyde condensate) |
| F | Mitsui XP04A | Modified polyolefin and | No additive |
| | | polyester solvent-based | |
| 13 | Mitsui XP04A | Modified polyolefin and | Citraconic anhydride |
| | | polyester solvent-based | |
| G | Mitsui S300 | Polyethylene-methacryalate | No additive |
| | | water-based | |
| 14 | Mitsui S300 | Polyethylene-methacryalate | Salicylic acid-Formaldehyde |
| | | water-based | condensate |
| H | Mitsui | Polyethylene KOH | No additive |
| | Chemipearl | neutralized water-based | |
| | W900 | | |
| 15 | Mitsui | Polyethylene KOH | Salicylic acid-Formaldehyde |
| | Chemipearl | neutralized water-based | condensate |
| | W900 | | |
| I | Mitsui | Polyethylene KOH | No additive |
| | Chemipearl | neutralized water-based | |
| | W950 | | |
| 16 | Mitsui | Polyethylene KOH | Salicylic acid-Formaldehyde |
| | Chemipearl | neutralized water-based | condensate |
| | W950 | | |
| J | DOW Canvera | Polyolefin dispersion water- | No additive |
| | 1110 | based | |
| 17 | DOW Canvera | Polyolefin dispersion water- | SFC 112-65 (t-Butylphenol- |
| | 1110 | based | Formaldehyde condensate) |
| 18 | DOW Canvera | Polyolefin dispersion water- | Salicylic acid-Formaldehyde |
| | 1110 | based | condensate |
| 19 | DOW Canvera | Polyolefin dispersion water- | NAN YA NPPN-631 (Novolac Epoxy |
| | 1110 | based | Resin) |
| 20 | DOW Canvera | Polyolefin dispersion water- | Salicylic acid-Glyoxal condensate |
| | 1110 | based | |
| 21 | DOW Canvera | Polyolefin dispersion water- | Citraconic anhydride |
| | 1110 | based | |
| 22 | DOW Canvera | Polyolefin dispersion water- | Citraconic anhydride (0.01 wt % added) |
| | 1110 | based | |
| 23 | DOW Canvera | Polyolefin dispersion water- | 1,3-bis(citraconimidomethyl)benzene |
| | 1110 | based | |
| 24 | DOW Canvera | Polyolefin dispersion water- | 1,3-bis(citraconimidomethyl)benzene |
| | 1110 | based | (0.01 wt % added) |
| K | DOW Canvera | Polyolefin dispersion water- | 4,4′-methylene bis(2,6-ditert- |
| | 1110 | based | butylphenol |
| L | DOW Canvera | Polyolefin dispersion water- | 4,4′-methylene bis(2,6-ditert- |
| | 1110 | based | butylphenol (0.01 wt % added) |
| M | DOW Canvera | Polyolefin dispersion water- | Condensate of 2-tert-butylphenol and |
| | 1110 | based | formaldehyde |
| N | DOW Canvera | Polyolefin dispersion water- | Condensate of 2-tert-butylphenol and |
| | 1110 | based | formaldehyde |
| O | DOW Canvera | Polyolefin dispersion water- | Condensate of 2-tert-butylphenol and |
| | 1110 | based | formaldehyde capped with 2,6-di-tert- |
| | | | butylphenol (0.01 wt % added) |
| P | DOW Canvera | Polyolefin dispersion water- | Condensate of 2-tert-butylphenol and |
| | 1110 | based | formaldehyde capped with 2,6-di-tert- |
| | | | butylphenol (0.01 wt % added) |
| Q | DOW Canvera | Polyolefin dispersion water- | Condensate of 2-tert-butylphenol and |
| | 1110 | based | formaldehyde capped with 2,6-di-tert- |
| | | | butylphenol (0.5 wt % added) |

1,3-bis(citraconimidomethyl)benzene, and is an inhibitor in accordance with the invention comprising both an allylic and a benzylic moiety.

An aluminium dish (diameter of 10 cm) is charged with 200 mg of the mixture and distributed homogeneously over the dish surface. The dishes are allowed to dry for 3 minutes at 190° C. in a box oven. The overbake was measured by leaving the dishes for an additional 10 minutes, and also for an additional 30 minutes. The surface of the dried film was subsequently exposed to a heat gun for 30 seconds at 300° C. and/or for 5 minutes at 300° C. and evaluated. The evaluations are tabulated in the Table below. The rankings rate from “1” to “5”, whereby “1” denotes a “very bad, decomposed coating” and “5” denotes “good, no change to the coating”.

| | Overbake | Overbake | Heatgun | |
|---|---|---|---|---|
| | (10 min at | (30 min at | (30 s at | Heatgun |
| Example | 190° C.) | 190° C.) | 300° C.) | (5 min at 300° C.) |
| E | 5 | 5 | 5 | 1 |
| 12 | 5 | 5 | 5 | 5 |
| F | 3 | 1 | 1 | n.d. |
| 13 | 5 | 4 | 4 | n.d. |
| G | 2 | 1 | 1 | n.d. |
| 14 | 5 | 5 | 5 | n.d. |
| H | 3 | 1 | 1 | n.d. |
| 15 | 5 | 3 | 3 | n.d. |
| I | 1 | 1 | 1 | n.d. |
| 16 | 5 | 3 | 3 | n.d. |
| J | 5 | 1 | 1 | n.d. |
| 17 | 5 | 5 | 5 | n.d. |
| 18 | 5 | 5 | 5 | n.d. |
| 19 | 5 | 5 | 5 | n.d. |
| 20 | 5 | 5 | 5 | n.d. |
| 21 | 5 | 5 | 5 | n.d. |
| 22 | 5 | 5 | 5 | n.d. |
| 23 | 5 | 5 | n.d. | n.d. |
| 24 | 5 | 5 | n.d. | n.d. |
| K | 5 | 2 | 1 | n.d. |
| L | 5 | 2 | 1 | n.d. |
| M | 5 | 1 | 1 | n.d. |
| N | 5 | 1 | 1 | n.d. |
| O | 5 | 2 | 1 | n.d. |
| P | 5 | 1 | 1 | n.d. |
| Q | 5 | 1 | 1 | n.d. |

It can be concluded from the Examples that radical-induced degradation reactions in various commercial polymer dispersions can be inhibited by functionalized allylic and benzylic compounds that are added at a catalytic level (i.e. 0.1 wt %). In Examples 22 and 24, it was observed that inhibitor amounts as low as 0.01wt % substantially improve the degradation reduction.

It is further noted that the condensates of Comparative Examples K to Q give rise to a much lower stability to the polymers than the inhibitors in accordance with the invention. The deterioration of the polymer after 30 min exposure to 190° C. is considerable which indicates that no catalytic scavenging properties were observed.

1. An inhibitor in a compound composition, the inhibitor to prevent oxidative radical degradation catalytically via a benzylic hydrogen abstraction mechanism, effective in an amount of less than 1% (w/w) based on the solid weight of substrate or substrate composition.

2. The compound according to claim 1, wherein the inhibitor comprises a conjugated benzyl moiety 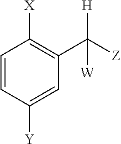
wherein X and Y are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics;
wherein the substitution on the aromatic ring can be ortho, meta para and higher substituted benzene molecules; and
wherein W and Z are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, amides, esters, carbonyls, epoxies, oxetanes, oxiranes, ethers, carboxylic acids, sulfonates, sulfonic acids, phosphonic acids and heterocyclics.

3. The compound according to claim 2, wherein the inhibitor comprises at least one hydroxyl-substitution for X or Y.

4. The compound according to claim 2, wherein the inhibitor comprises at least one aryl or substituted aryl functionality for substituent W or Z.

5. The compound according to claim 2, wherein the inhibitor is one of a condensated phenol resin, a mono-substituted phenol, a bis-substituted phenol, and a tri-substituted phenol.

6. The compound according to claim 2, wherein the benzene group is replaced by a polycyclic aromatic compound.

7. The compound according to claim 2, wherein the benzene group is replaced by a suitable heterocyclic Hückel rule aromatic compound.

8. The compound according to claim 2, wherein the inhibitor further comprises a conjugated allylic-stabilized moiety.

9. The compound according to claim 8, wherein the conjugated allylic-stabilized molecule is selected from the group consisting of itaconic acid, citraconic acid and a linear or cyclic anhydride thereof.

10. A compound comprising two or more inhibitors of claim 1.

11. The compound according to claim 1, wherein the substrate is one of a polymer, oligomer, monomer, and reactive solvent.

12. The compound according to claim 11, wherein the polymer comprises alkene moieties.

13. The compound according to claim 1, wherein the substrate is selected from the group consisting of polyethylene, polypropylene, polybutadiene, polyisoprene, polyhexene or copolymers thereof, and grafted polymers.

14. The compound according to claim 1, wherein the substrate is selected from the group consisting of acrylate, methacrylate, styrene, divinylbenzene, natural oils or corresponding fatty acids, food stuff, wine and beverages.

15. The compound according to claim 1, wherein the substrate contains a reactive C—H bond selected from the group consisting of toluene, xylene, cumene, benzylalcohol and benzaldehyde.

16. The compound according to claim 1, wherein the inhibitor is effective in an amount of less than 0.5% (w/w) based on the solid weight of the substrate or substrate composition.

17. A composition capable of limiting oxidative radical degradation catalytically via a benzylic hydrogen abstraction mechanism, comprising a polymer and an inhibitor of the formula: 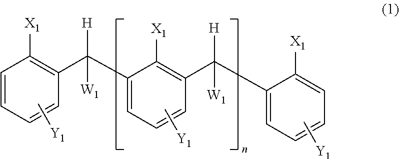
wherein n is a number from 0 to 1000;
wherein X₁ and Y₁ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics;
wherein the substitution on the aromatic ring can be ortho, meta, para or higher substituted benzene molecules; and
wherein W₁ is independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, amides, esters, carbonyls, epoxies, oxetanes, oxiranes, ethers, carboxylic acids, sulfonates, sulfonic acids, phosphonic acids and heterocyclics.

18. The composition according to claim 17, wherein the amount of the inhibitor of formula (1) is at most 40 wt %, based on the total weight of the composition.

19.-20. (canceled)

21. Inhibitor of formula (1) 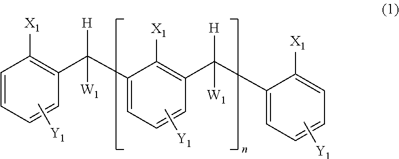
wherein X₁ and Y₁ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics;
wherein the substitution on the aromatic ring can be ortho, meta, para or higher substituted benzene molecules; and
wherein W₁ is independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, amides, esters, carbonyls, epoxies, oxetanes, oxiranes, ethers, carboxylic acids, sulfonates, sulfonic acids, phosphonic acids and heterocyclics.

22. Process for preparing a polymer obtainable by polymerization of at least one ethylenically unsaturated monomer comprising:
providing a reaction mixture comprising at least one ethylenically unsaturated monomer and optionally a solvent;
polymerizing at least one ethylenically unsaturated monomer to form a (co)polymer; and
adding the compound of formula (1) to the ethylenically unsaturated monomer: 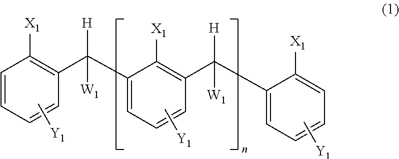
wherein X₁ and Y₁ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics;
wherein the substitution on the aromatic ring can be ortho, meta, para and higher substituted benzene molecules; and
wherein W₁ is independently selected from hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, amides, esters, carbonyls, epoxies, oxetanes, oxiranes, ethers, carboxylic acids, sulfonates, sulfonic acids, phosphonic acids and heterocyclics,

23. The process according to claim 22, wherein the compound of formula (1) is added in an amount sufficient to end the radical polymerization.

24. A process for preparing the composition of claim 17 comprising: 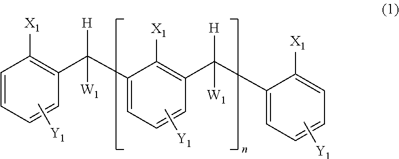
contacting the polymer and the inhibitor of formula (1); and mixing the polymer and the inhibitor of formula (1) to form the composition.

25. A composition capable of limiting oxidative radical degradation catalytically via allylic hydrogen abstraction mechanism, comprising a polymer and an inhibitor of the formula: 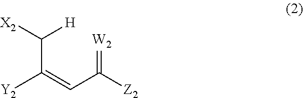
wherein X₂ and Y₂ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics, wherein the substitution on the aromatic ring can be ortho, meta, para and higher substituted aromatic rings;
wherein W₂ is selected from the group consisting of oxygen, sulphur, nitrogen-containing groups and phosphor-containing groups; and
wherein Z₂ is selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, amino derivative or the corresponding salts (ligands), ketones, aldehydes, ethers, carboxylic acids, sulfonates, sulfonic acids, phosphonic acids and heterocyclics, wherein the substitution on the aromatic ring can be ortho, meta, para and higher substituted aromatic rings.

26. The composition according to claim 25, wherein the amount of the inhibitor of formula (2) is at most 40 wt %, based on the total weight of the composition.

27.-28. (canceled)

29. Inhibitor of formula (2) 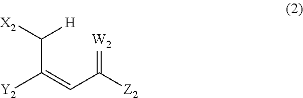
wherein X₂ and Y₂ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics, wherein the substitution on the aromatic ring can be ortho, meta, para and higher substituted aromatic rings;
wherein W₂ is selected from the group consisting of oxygen, sulphur, nitrogen-containing groups and phosphor-containing groups; and
wherein Z₂ is selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, amino derivative or the corresponding salts (ligands), ketones, aldehydes, ethers, carboxylic acids, sulfonates, sulfonic acids, phosphonic acids and heterocyclics, wherein the substitution on the aromatic ring can be ortho, meta, para and higher substituted aromatic rings.

30. Process for preparing a polymer obtainable by polymerization of at least one ethylenically unsaturated monomer comprising:
providing a reaction mixture comprising at least one ethylenically unsaturated monomer and optionally a solvent;
polymerizing at least one ethylenically unsaturated monomer to form a (co)polymer; and
adding the compound of formula (2) to the ethylenically unsaturated monomer: 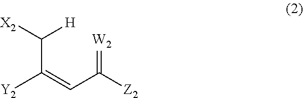
wherein X₂ and Y₂ are each independently selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, ketones, aldehydes, ethers, carboxylic acids, sulfonates, sulfonic acids, phosphonic acids and heterocyclics, wherein the substitution on the aromatic ring can be ortho, meta, para and higher substituted aromatic rings;
wherein W₂ is selected from the group consisting of oxygen, sulphur, nitrogen-containing groups and phosphor-containing groups; and
wherein Z₂ is selected from the group consisting of hydrogen, alkyl, alkenyl, alkynyl, aryl, substituted alkyls, substituted alkenyl, substituted alkynyl, substituted aryls, polycylic aromatics, substituted polycyclic aromatics, polar functional groups, alcohol, amines, amino derivative or the corresponding salts (ligands), ketones, aldehydes, ethers, carboxylic acids, sulfonates, sulfonic acids, phosphonic acids and heterocyclics, wherein the substitution on the aromatic ring can be ortho, meta, para and higher substituted aromatic rings.

31. The process according to claim 30, wherein the compound of formula (2) is added in an amount sufficient to end the radical polymerization.

32. A process for preparing the composition of claim 25 comprising: 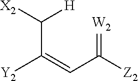
contacting the polymer and the inhibitor of formula (2); and
mixing the polymer and the inhibitor of formula (2) to form the composition.

33. The compound according to claim 1, wherein the benzene group is replaced by a compound selected from the group consisting of naphthalene, anthracene and phenanthrene.

34. The compound according to claim 1, wherein the benzene group is replaced by a compound selected from the group consisting of pyridine, thiophene, 1,3,5-triazine and melamine.

35. The compound according to claim 1, wherein the inhibitor is effective in an amount of less than 0.2% (w/w) based on the solid weight of substrate or substrate composition.

36. The compound according to claim 1, wherein the inhibitor is effective in an amount of less than 0.05% (w/w) based on the solid weight of substrate or substrate composition.

37. The process according to claim 22, wherein the compound of formula (1) is added to the ethylenically unsaturated monomer prior to the step of polymerizing.

38. The process according to claim 22, wherein the compound of formula (1) is added to the ethylenically unsaturated monomer during the step of polymerizing.

39. The process according to claim 30, wherein the compound of formula (2) is added to the ethylenically unsaturated monomer prior to the step of polymerizing.

40. The process according to claim 30, wherein the compound of formula (2) is added to the ethylenically unsaturated monomer during the step of polymerizing.
